(19) United States
(12) Patent Application Publication
(10) Pub. No.: US 2016/0294823 A1
(43) Pub. Date: Oct. 6, 2016

(54) DISPLAYING CONTENT BASED ON DEVICE ORIENTATION

(71) Applicant: AirWatch LLC, Atlanta, GA (US)

(72) Inventor: Kevin Marshall McKeithan, II, Forth Worth, TX (US)

(21) Appl. No.: 14/673,473

(22) Filed: Mar. 30, 2015

(51) Int. Cl. H04L 29/06; G06K 9/00; G06F 21/62; G06F 3/01

(52) U.S. Cl. CPC H04L 63/0861; G06F 3/017; G06F 3/012; G06K 9/00288; G06F 21/629; G06F 2221/2125

(57) ABSTRACT

Discloses are various embodiments for rendering or hiding data based at least in part on the current orientation of a client device. The client device determines its current orientation based at least in part on data provided by a sensor of the client device. The client device then determines that data currently rendered on a display of the client device is to be hidden based at least in part on the current orientation of the client device. The client device then removes the data from the display of the client device.

### BACKGROUND

Client devices are often used to consume digital data. For example, client devices, such as tablets, phones, and other portable devices, may used to watch videos, read letters, memos, articles, emails, or other documents, and consume other types of data. Some of this data may be sensitive or intended be confidential. For example, the data may include documents intended for review by select individuals.

However, viewing sensitive or confidential data on a client device may result in unintended disclosure of the data. For example, when a user views sensitive data around other people, there is a risk that an unintended user may also view the sensitive data. As another example, a user may set a tablet down on a table and walk away temporarily with the sensitive data on the display, leaving it open to compromise by unauthorized users.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1A is a drawing depicting use of an exemplary client device.

FIG. 1B is a drawing depicting use of an exemplary client device.

FIG. 2 is a schematic block diagram of a client device according to various embodiments of the present disclosure.

FIG. 3 is a flowchart illustrating one example of functionality implemented in a client device according to various embodiments of the present disclosure.

FIG. 4 is a flowchart illustrating one example of functionality implemented in a client device according to various embodiments of the present disclosure.

FIG. 5 is a flowchart illustrating one example of functionality implemented in a client device according to various embodiments of the present disclosure.

### DETAILED DESCRIPTION

Disclosed are various examples for displaying data on a client device based at least in part on the orientation of the client device. For example, a sensor within the client device can detect an orientation of the client device, such as whether the client device is laying flat, is standing vertically, or is in an angled position. Based on the current orientation of the client device, data that is currently selected for display can be displayed or can be hidden. For example, sensitive data (e.g. sensitive such as documents, audio, or video and/or sensitive applications such as financial applications) can be displayed when the client device is oriented at an angle, indicating that a user is holding the client device to consume the sensitive data. When the orientation of the client device changes, such as when a user lays a tablet or phone on a table, the sensitive data can be hidden from view in order to protect the sensitive data from unauthorized consumption, such as unauthorized viewing by a third-party.

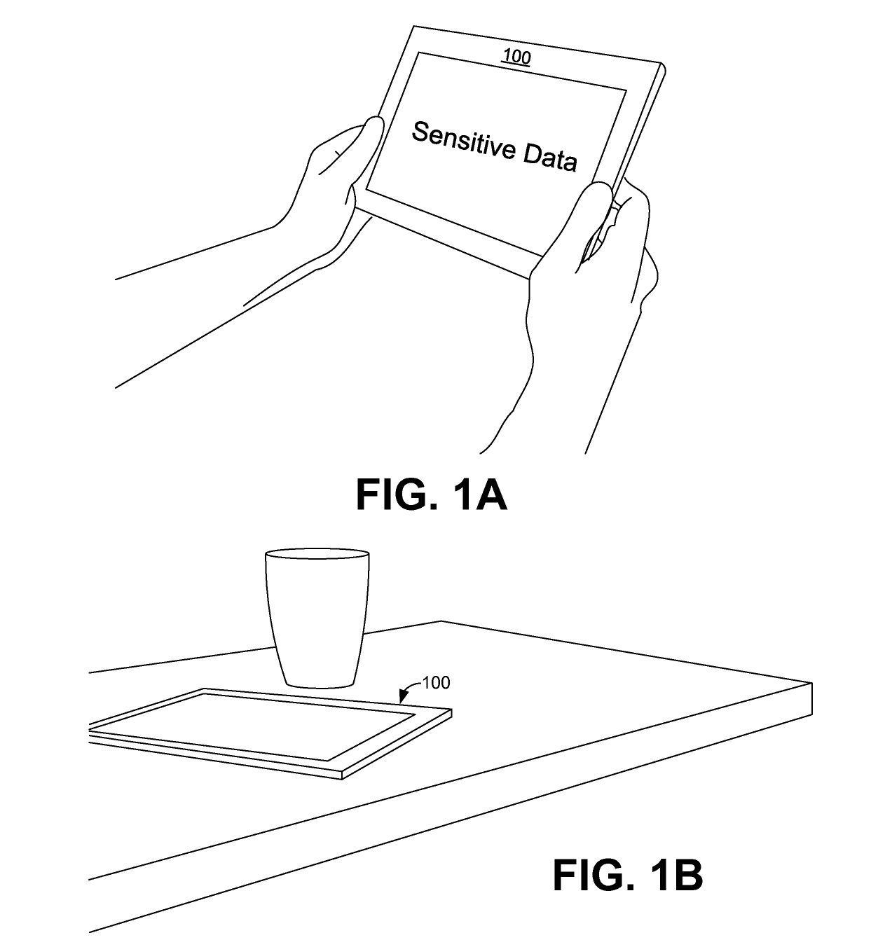

With reference to FIG. 1A, shown is an illustrative and non-limiting example of a client device 100. The client device 100 corresponds, for example, to a processor-based computer system. According to various examples, a client device 100 is embodied in the form of a desktop computer, a laptop computer, a personal digital assistant, a mobile phone, a web pad, or a tablet computer system. The client device 100 includes output devices, such as a display and audio speakers, as well as one or more input devices, such as a mouse, keyboard, touch pad, or touch screen, which facilitate a user interacting with the client device 100.

As illustrated in FIG. 1A, a user is holding the client device 100 in his or her hands to view sensitive data. As will be explained in further detail below, the client device 100 can determine its orientation relative to a reference plane, such as the ground, a vertical reference, or other reference plane. Because the orientation of the client device 100 falls within one or more predefined parameters, the client device 100 can determine that the user is holding the client device 100 to consume the sensitive data. Accordingly, the client device 100 renders the sensitive data to the user.

With reference to FIG. 1B, the client device 100 previously depicted in in FIG. 1A has been placed down on a table as illustrated. The client device 100 has detected the change in its orientation and determined that its orientation indicates that the user can no longer be consuming the sensitive data previously rendered by the client device 100. Accordingly, the client device 100 has ceased rendering the sensitive data in order to avoid unauthorized users from consuming the sensitive data. In some embodiments, the client device 100 can have further caused a lock screen to be activated in response to the change in orientation, which can require a user to enter a personal identification number (PIN), a passcode, swipe a touchscreen of a client device in a particular manner, or perform some other action to continue using the client device 100.

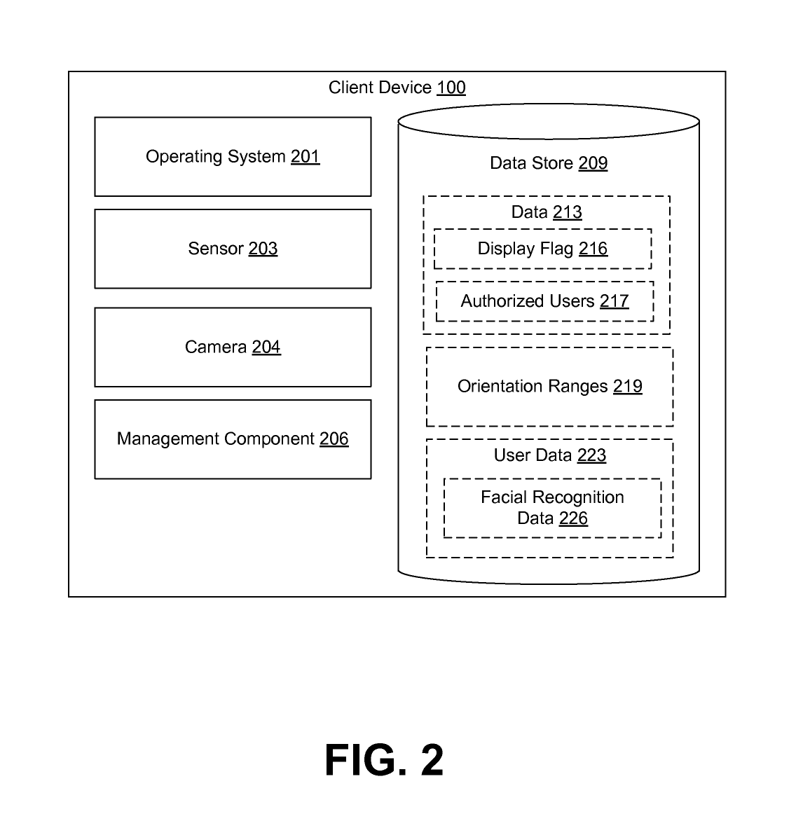

With reference to FIG. 2, shown is schematic diagram of the client device 100. In addition to various processors, memories, displays, and network interfaces, the client device 100 can also include an operating system 201, one or more sensors 203, and/or a camera 204. The client device 100 can also be configured to execute a management component 206, as well as other applications. The client device 100 can also include a data store 209. The data stored in the data store 209 can include data 213 to be rendered by the client device 100, acceptable orientation ranges 219 for viewing data 213, as well as other data.

The operating system 201 can manage hardware and/or software resources of the client device 100, including providing various services to one or more applications executing on the client device 100. To provision these services, the operating system 201 can make one or more application programming interfaces (APIs) available for use by the various applications executing on the client device 100. For example, the operating system 201 can make an API available to applications, such as the management component 206, that provide data generated by one or more sensors 203. Applications can call one or more functions provided by the API to retrieve the data generated by the sensors 203.

The sensor 203 can represent one or more sensors capable of detecting the current orientation of the client device 100, changes in the orientation of the client device 100, or generating data from which the current orientation or changes in the orientation of the client device 100 can be derived, as well as other sensors. A sensor 203 can include, for example, an accelerometer, one or more gyroscopes, and/or other sensors. In various embodiments, microelectromechanical systems (MEMS) accelerometers, gyroscopes, and/or other sensors can be used.

The camera 204 can include one or more image acquisition devices, such as a photographic camera or a video camera. A client device 100 can, for example, have a camera 204 on the same side or facing in the same direction as the display of the client device 100 (e.g a “front-facing” camera). A client device 100 can also, for example, have a camera 204 on the side of the client device 100 opposing the display (e.g. a “rear-facing” camera).

The management component 206 can be executed in the client device 100 to monitor and manage data, software components, and hardware components of the client device 100. For example, the management component 206 can determine or identify the current orientation of the client device 100 based at least in part on data generated by or provided by one or more sensors 203. In some embodiments, the management component 206 can query the sensor 203 directly, while in other embodiments the management component 206 use an application programming interface (API) function call provided by an operating system of the client device 100 to identify the orientation of the client device 100. The management component 206 can also determine whether or not to render particular items of data 213 based at least in part on the orientation of the client device 100.

The data 213 can represent a digital representation of any media to be rendered by the client device 100 for consumption by a user of the client device 100. Data 213 can include text, audio, video, images, as well as documents that include a combination of text, audio, video, and/or images. In one example, each item of data 213 can also have a corresponding display flag 216. The display flag 216 can indicate whether an item of data 213 is to be rendered or not based at least in part on the current, previous, and/or predicted orientation of the client device 100. For example, the display flag 216 can have a value of “hidden” or “protected” if data 213 is to be rendered based on orientation and some other value of data 213 is to be rendered independent of the orientation of the client device 100. In one example, each item of data 213 can also include a list of authorized users 217. The list of authorized users 217 may include a list of usernames, account identifiers, or similar data that identifies the user accounts of users who are authorized to view or otherwise consume the data 213.

Orientation ranges 219 represent one or more permissible orientations of the client device 100 for viewing data 213 when the display flag 216 for the data 213 indicates that the data 213 is “hidden” or “protected.” An orientation range 219 can, for example, specify a range of angles of the client device 100 and/or the display of client device 100 with respect to a reference plane, such as the ground or plane parallel to the ground, a vertical plane perpendicular to the ground, and/or other planes. For example, an orientation range 219 can specify that “protected” or “hidden” data 213 can be rendered only when the client device 100 and/or the display of the client device 100 forms an angle greater than 30° but less than 60° with respect to the reference plane.

User data 223 may include data related to various users of the client device 100, such as user name, authentication credentials, file permissions, application permissions, application settings, and other data. User data 223 may also include facial recognition data 226. Facial recognition data 226 can include any data that can be used to match a face of a person, such as a face in an image or video, to a specific user. For example, facial recognition data 226 may include one or more images of the face of the user. As another example, facial recognition data 226 can include a set of points, edges, skin textures, and similar data that can be used to match a face in an image to a face of the user.

Other ranges of angles can be specified according to the requirements of various embodiments of the present disclosure, and more than one orientation range 219 can be specified for a client device 100. Moreover, in some embodiments, multiple orientation ranges 219 can be specified for different types of data 213, to reflect the fact that users of a client device 100 can position the client device 100 differently depending on the type of data 213 being consumed. For example, a user can lay a client device 100 flat in order to listen to audio data 213 but hold the client device 100 upright or at an angle to read text data 213 or watch video data 213.

Next, a general description of the operation of the various components of the client device 100 is provided. To begin, a user starts consuming data 213 on the client device 100, such as reading a document, watching a video, listening to a recording, or otherwise consuming some form of data 213. The management component 206 then determines whether rendering of the data 213 is to be governed by the current orientation of the client device 100 by checking the setting of the display flag 216 for the data 213.

If the display flag 216 indicates that consumption of the data 213 is protected, then the management component 206 determines the current orientation of the client device 100. The management component 100 can, for example, determine the current orientation from positional data generated by one or more sensors 203, such as one or more gyroscopes. The management component 100 can query the sensors 203 directly or, in some embodiments, can use an API function call provided by the operating system of the client device 100 to retrieve data from the sensors 203.

The management component 206 can then determine whether the current orientation of the client device 100 falls within one or more specified orientation ranges 219. If the current orientation of the client device 100 falls within an orientation range 219, then rendering of the data 213 can continue. However, if the current orientation of the client device 100 falls outside of an orientation range 219, then the management component 206 can hide the data 213 or otherwise cause the client device 100 to stop rendering the data 213. In some embodiments, the management component 206 can compare the current orientation of the client device 100 with an orientation range 219 specific to the type of data 213 being rendered or consumed. For example, users can position their client device 100 differently to read text data 213 than to listen to audio data 213, and therefore a different orientation range 219 can be specified for each type of data 213.

The management component 206 can take, or otherwise cause the client device 100 to take, any one or more of a number of actions in order to hide or secure the data 213 when the client device 100 is not oriented in a proper manner. The management component 206 can, for example, cause the client device 100 to dim or power-off its display, to mute the speakers of the client device 100, to replace the data 213 with other data 213 that is not have its display flag 216 marked as “hidden” or “protected,” or to simply stop rendering the data 213. In various embodiments, the management component 203 can also cause the client device 100 to enter a locked state that requires a user to enter a PIN, password, or similar authentication credential, in order to resume using the client device 100.

The management component 206 can continue to monitor the orientation of the client device 100. Upon detecting a change in the current orientation of the client device 100, the management component can compare the new orientation of the client device with one or more orientation ranges 219. If the client device 100 is in a new orientation that complies with one of the specified orientation ranges 219, then the client device 100 can cause the client device 100 to resume displaying and/or otherwise rendering the data 213. However, if the new orientation of the client device 100 does not comply with one or more of the specified orientation ranges 219, then the management component 206 can continue to cause the client device to hide or otherwise not render the data 213.

The management component 206 can also determine whether or not data 213 should be rendered or hidden based on other conditions. For example, the management component 206 can determine that another device is paired to the client device 100. For example, the management component 206 could determine that a smartphone, smartwatch, or other mobile or wearable computing device is connected to the client device 100 over a Bluetooth® or near field communication (NFC) connection. The management component 206 could always cause the sensitive data 213 to be rendered so long as the client device 100 remains connected to the other device. As another example, the management component 206 can identify the network that the client device 100 is currently connected to, such as a specific wireless network. The wireless network may be associated with a specific location that is presumed to be safe and/or secure (e.g. company headquarters). The management component 206 could always causes the sensitive data 213 to be rendered so long as the client device 100 remains connected to the specific wireless network.

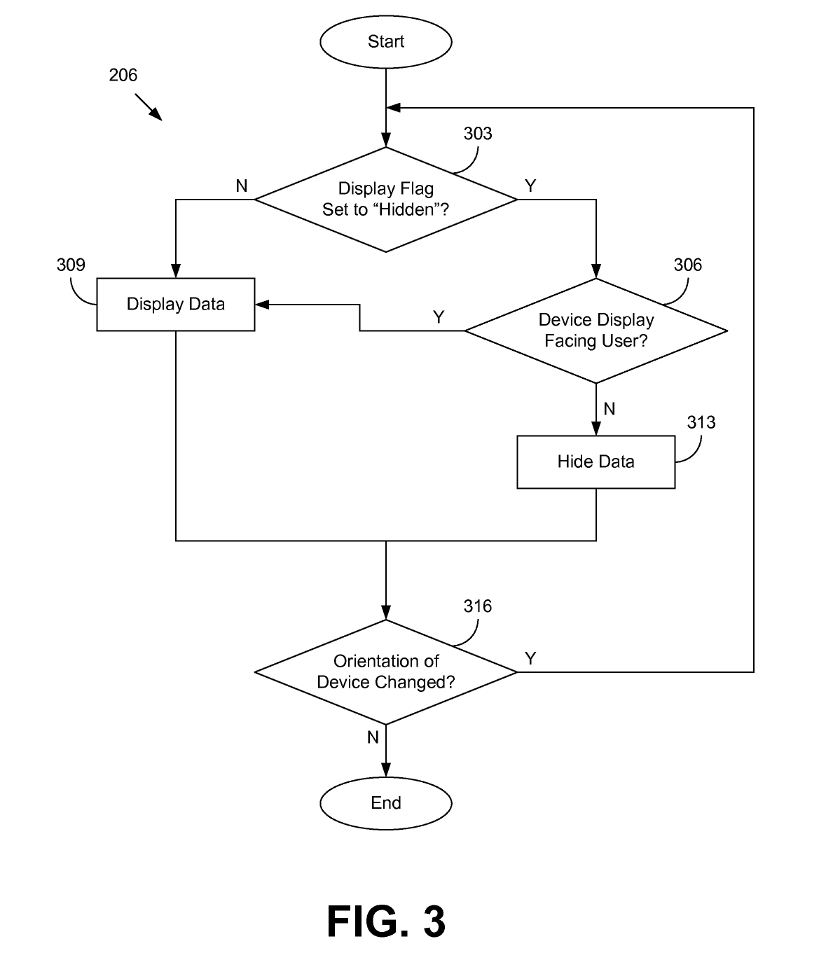

Referring next to FIG. 3, shown is a flowchart that provides one example of the operation of a portion of the management component 206 of FIG. 2, according to various embodiments. It is understood that the flowchart of FIG. 3 provides merely one example of the many different types of functional arrangements that can be employed to implement the operation of the portion of the management component 206 as described below. As an alternative, the flowchart of FIG. 3 can be viewed as depicting an example of elements of a method implemented in the client device 100 (FIG. 2) according to one or more embodiments.

Beginning with step 303, the management component 206 can analyze a display flag 216 (FIG. 2) of an item of data 213 (FIG. 2) that a user has selected for rendering on the client device 100. If the display flag 216 (FIG. 2) indicates that rendering of the data 213 is based at least in part on the current orientation of the client device 100, then execution proceeds to step 306. Otherwise, execution proceeds to step 309.

Moving on to step 306, the management component 206 can determine the current orientation of the client device 100 and/or the display of the client device 100. For example, the management component 206 can query a sensor 203 (FIG. 2), such as a gyroscope, or invoke a function provided by an API of the operating system 201 (FIG. 2) to identify the orientation of the client device 100 along one or more axes with respect to a reference plane or planes, such as the ground. In such an example, the sensor 203 can report that the client device is tilted at a 30° angle with respect to the ground or other reference plane, in which case the management component 206 identifies the orientation of the client device 100 as being oriented at 30° with respect to the ground or other reference plane. In other embodiments, the management component 206 can calculate or derive the orientation based at least in part upon data reported from one or more sensors 203.

After determining the orientation of the client device 100, the management component 206 can determine whether the angle of the client device 100 with respect to the reference plane falls within a range of angles specified in one or more orientation ranges 219 (FIG. 2). For example, if the orientation range 219 specifies a range of 30° to 60° from the reference plane and the orientation of the client device 100 is 30° from the reference plane, then the management component 206 can determine that the client device 100 and/or display of the client device 100 are facing the user. In response, the previously described process can proceed to step 309. However, if the orientation of the client device 100 falls outside of any of the orientation ranges 219, then the previously described process can proceed to step 313. For example, if the orientation range 219 specifies a range of 45° to 70° from the reference plane, but the orientation of the client device 100 is 35° from the reference plane, then the management component can determine that the client device 100 and/or display of the client device 100 are not facing the user, causing the previously described process to proceed to step 313.

In some examples, a user may open a document at any range since a user might want to view sensitive data, for example a sensitive document, while a tablet is lying flat or otherwise outside the accepted ranges. In these examples, a user may have to enter a password before displaying the sensitive data, or have entered their device password recently, such as within the last thirty seconds or other predefined amount of time.

Proceeding next to step 309, the management component 206 can cause the client device to render the data 213. The data 213 can be presented on a display of the client device 100, such as documents, text, images, and/or video, or rendered via other output devices, such as speakers for audio data 213.

However, referring back to step 313, the management component 206 can hide the data 213 to prevent consumption of the data by unauthorized users. For example, the management component 206 can replace the data 213 with other data 213, such as replacing sensitive documents with a news article or replacing sensitive images with stock images, a watermark, a logo, or other placeholder data. In some embodiments, the management component 206 can simply cease rendering the data 213.

In various other embodiments, the management component 206 can power off and/or dim the display of the client device 100 or mute the speakers of the client device 100, depending on the type of data 213 being hidden. For example, the management component 206 can dim and/or power off the display of the client device 100 when hiding text, images, and/or video data 213. The management component 206 can also mute the speakers and/or volume of the client device 100 when hiding audio and/or video data 213.

Moreover, in various embodiments, the management component 206 can cause the client device 100 to enter a locked state. The locked state can prevent the client device 100 from being used until a user supplies a personal identification number (PIN), passcode, password, or other authentication credential, to cause the client device 100 to switch from the locked state to an unlocked state. For example, the management component 206 can cause a “lock screen” or similar interface provided by the operating system 201 to be rendered on a display of the client device 100. The “lock screen” can prompt the user to enter a personal identification number (PIN), passcode, password, or other authentication credential. When hiding data at step 313, the management component 206 may notify a user by displaying a message that the device orientation cannot be used for the selected data 213. A user may override this setting, for example, by entering their password.

Moving on to step 316, the management component 206 can determine whether the angle and/or orientation of the client device 100 has changed. The management component 206 can make this determination, for example, by identifying the current angle and/or orientation of the client device 100 and comparing it to the angle and/or orientation identified previously at step 306. If the angle and/or orientation of the client device 100 has changed, then the previously described process loops back to step 303. Users and system administrators may also define an acceptable amount of time during which a device can be in an unauthorized orientation before hiding or otherwise restricting access to the document. For example, restrictive actions can be deferred for ten seconds to allow repositioning into an acceptable orientation. However, if the angle and/or orientation of the client device 100 has not changed, then the previously described process can end or, in some embodiments, wait until a change in the angle and/or orientation of the client device 100 is detected.

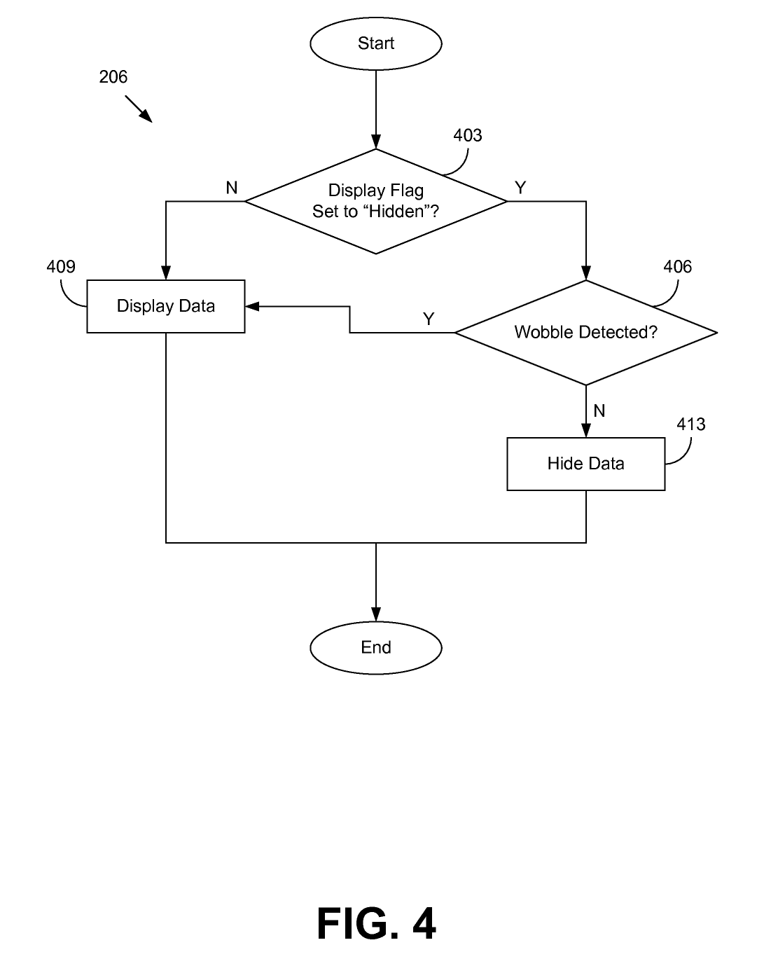

Referring next to FIG. 4, shown is a flowchart that provides one example of the operation of a portion of the management component 206 of FIG. 2, according to various embodiments. It is understood that the flowchart of FIG. 4 provides merely one example of the many different types of functional arrangements that can be employed to implement the operation of the portion of the management component 206 as described below. As an alternative, the flowchart of FIG. 4 can be viewed as depicting an example of elements of a method implemented in the client device 100 (FIG. 2) according to one or more embodiments.

Beginning with step 403, the management component 206 can analyze a display flag 216 (FIG. 2) of an item of data 213 (FIG. 2) that a user has selected for rendering on the client device 100. If the display flag 216 (FIG. 2) indicates that rendering of the data 213 is based at least in part on the current orientation of the client device 100, then execution proceeds to step 406. Otherwise, execution proceeds to step 409.

Moving on to step 406, the management component 206 can determine whether the client device 106 is shaking, wobbling, bobbing, or otherwise moving. Such movements can indicate that a user is holding the client device 100, instead of the client device 100 remaining perched on a surface, because a human can be unable to hold the client device 100 perfectly still. These movements can detected, for example, using one or more sensors 203 (FIG. 2) of the client device 100, such as accelerometers and/or gyroscopes. The sensors 203 can be queried directly by the management component 206 or, in some embodiments, the management component 206 can retrieve this information using a function call of an API provided by the operating system 201 of the client device 100.

Proceeding next to step 409, the management component 206 can cause the client device to render the data 213 while the display wobbles. In one example, a change outside of a predetermined orientation range can be allowed for an amount of time, such as three seconds, before hiding data (step 413 below) and/or prompting a user to enter a password to continue display of the data 213. The data 213 can be presented on a display of the client device 100, such as documents, text, images, and/or video, or rendered via other output devices, such as speakers for audio data 213.

However, referring back to step 413, the management component 206 hides the data 213 to prevent consumption of the data by unauthorized users. For example, the management component 206 can replace the data 213 with other data 213, such as replacing sensitive documents with a news article or replacing sensitive images with stock images. In some embodiments, the management component 206 can simply cease rendering the data 213.

In various other embodiments, the management component 206 can power off and/or dim the display of the client device 100 or mute the speakers of the client device 100, depending on the type of data 213 being hidden. For example, the management component 206 can dim and/or power off the display of the client device 100 when hiding text, images, and/or video data 213. The management component 206 can also mute the speakers and/or volume of the client device 100 when hiding audio and/or video data 213.

Moreover, in various embodiments, the management component 206 can cause the client device 100 to enter a locked state. The locked state can prevent the client device 100 from being used until a user supplies a personal identification number (PIN), passcode, password, or other authentication credential, to cause the client device 100 to switch from the locked state to an unlocked state. For example, the management component 206 can cause a “lock screen” or similar interface provided by the operating system 201 to be rendered on a display of the client device 100. The “lock screen” can prompt the user to enter a personal identification number (PIN), passcode, password, or other authentication credential.

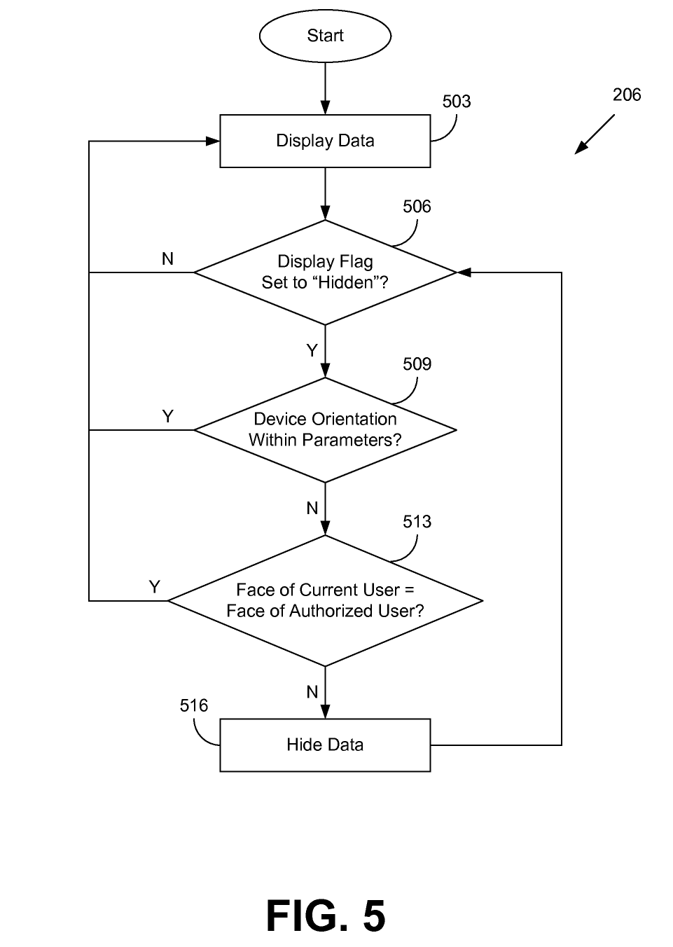

With reference to FIG. 5, shown is a flowchart that provides one example of the operation of a portion of the management component 206 of FIG. 2, according to various embodiments. It is understood that the flowchart of FIG. 5 provides merely one example of the many different types of functional arrangements that can be employed to implement the operation of the portion of the management component 206 as described below. As an alternative, the flowchart of FIG. 5 can be viewed as depicting an example of elements of a method implemented in the client device 100 (FIG. 2) according to one or more embodiments.

Beginning with step 503, the management component 206 renders the data 213 on a display of the client device 100. For example, the management component 206 may permit a document or video to be rendered or an application executing on the client device 100 to display data 213. For example, the management component 206 may check various permissions and allow the data 213 to be rendered on the display of the client device 100.

Moving on to step 506, the management component 206 can analyze a display flag 216 (FIG. 2) of an item of data 213 (FIG. 2) that a user has selected for rendering on the client device 100. If the display flag 216 (FIG. 2) indicates that rendering of the data 213 is based at least in part on the current orientation of the client device 100, then execution proceeds to step 509. Otherwise, execution proceeds back to step 503, so that the client device can continue to display the data 213.

Proceeding next to step 509, the management component 206 can determine whether the orientation of the client device 100 is within at least one of the orientation ranges 219 (FIG. 2). For example, the management component 206 can query a sensor 203 (FIG. 2), such as a gyroscope, or invoke a function provided by an API of the operating system 201 (FIG. 2) to identify the orientation of the client device 100 along one or more axes with respect to a reference plane or planes, such as the ground. In such an example, the sensor 203 can report that the client device is tilted at a 30° angle with respect to the ground or other reference plane, in which case the management component 206 identifies the orientation of the client device 100 as being oriented at 30° with respect to the ground or other reference plane. In other embodiments, the management component 206 can calculate or derive the orientation based at least in part upon data reported from one or more sensors 203.

After determining the orientation of the client device 100, the management component 206 can determine whether the angle of the client device 100 with respect to the reference plane falls within a range of angles specified in one or more orientation ranges 219. For example, if the orientation range 219 specifies a range of 30° to 60° from the reference plane and the orientation of the client device 100 is 30° from the reference plane, then the management component 206 can determine that the client device 100 and/or display of the client device 100 are facing the user. In response, the previously described process can proceed back to step 503 so that the client device 100 can continue to display the data 213 to the user. However, if the orientation of the client device 100 falls outside of any of the orientation ranges 219, then the previously described process can proceed to step 513. For example, if the orientation range 219 specifies a range of 45° to 70° from the reference plane, but the orientation of the client device 100 is 35° from the reference plane, then the management component can determine that the client device 100 and/or display of the client device 100 are not facing the user, causing the previously described process to proceed to step 513.

Referring next to step 513, the management component 206 can conduct facial recognition to determine whether the user viewing the data 213 is authorized to view the data 213. For example, the management component 206 may cause a camera 204 (FIG. 2) of the client device 100 to take a photograph of the user. The management component 206 can then use one or more face detection techniques, such as a principal component analysis using eigenfaces, a linear discrete analysis, elastic bunch graph matching using the Fisherface algorithm, a hidden Markov model, multilinear subspace learning using tensor representation, and/or neuronal motivated dynamic link matching, in order to identify various facial features present in the image. In this example, the management component 206 can then compare the identified facial features with the facial recognition data 226 (FIG. 2) in the user data 223 (FIG. 2) of the authorized users 217 (FIG. 2) for the data. If the identified facial features match the facial recognition data 226 of one of the authorized users 217, then the management component 206 can determine that the data 213 is being viewed by an authorized user. In this case, the process loops back to step 503 so that the data 213 can continue to be displayed to the user. If no match is made, the management component 206 can determine that no authorized user is currently viewing the data 213. In this instance, the process proceeds on to step 516.

Moving on to step 516, the management component 206 can hide the data 213 to prevent consumption of the data by unauthorized users. For example, the management component 206 can replace the data 213 with other data 213, such as replacing sensitive documents with a news article or replacing sensitive images with stock images, a watermark, a logo, or other placeholder data. In some embodiments, the management component 206 can simply cease rendering the data 213.

In various other embodiments, the management component 206 can power off and/or dim the display of the client device 100 or mute the speakers of the client device 100, depending on the type of data 213 being hidden. For example, the management component 206 can dim and/or power off the display of the client device 100 when hiding text, images, and/or video data 213. The management component 206 can also mute the speakers and/or volume of the client device 100 when hiding audio and/or video data 213.

Moreover, in various embodiments, the management component 206 can cause the client device 100 to enter a locked state. The locked state can prevent the client device 100 from being used until a user supplies a personal identification number (PIN), passcode, password, or other authentication credential, to cause the client device 100 to switch from the locked state to an unlocked state. For example, the management component 206 can cause a “lock screen” or similar interface provided by the operating system 201 to be rendered on a display of the client device 100. The “lock screen” can prompt the user to enter a personal identification number (PIN), passcode, password, or other authentication credential. When hiding data 213 at step 313, the management component 206 may notify a user by displaying a message that the device orientation cannot be used for the selected data 213. A user may override this setting, for example, by entering their password.

In some examples, the process can then loop back to step 506 after hiding the data. The process then repeats the previously described checks to determine whether or not an authorized user or an unauthorized user is attempting to view the data 213. However, in some examples, the previously described process can end after the data 213 is hidden in the manner described above.

The flowcharts of FIG. 3-5 show examples of the functionality and operation of implementations of components described below. The components described below can be embodied in hardware, software, or a combination of hardware and software. If embodied in software, each element can represent a module of code or a portion of code that comprises program instructions to implement the specified logical function(s). The program instructions can be embodied in the form of source code that comprises human-readable statements written in a programming language and/or machine code that comprises machine instructions recognizable by a suitable execution system, such as a processor in a computer system or other system. If embodied in hardware, each element can represent a circuit or a number of interconnected circuits that implement the specified logical function(s).

Although the flowcharts of FIG. 3-5 show a specific order of execution, it is understood that the order of execution can differ from that which is shown. The order of execution of two or more elements can be switched relative to the order shown. Also, two or more elements shown in succession can be executed concurrently or with partial concurrence. Further, in some embodiments, one or more of the elements shown in the flowcharts can be skipped or omitted. In addition, any number of counters, state variables, warning semaphores, or messages might be added to the logical flow described below, for purposes of enhanced utility, accounting, performance measurement, troubleshooting aid, etc. It is understood that all such variations are within the scope of the present disclosure.

It is further understood that the functionality depicted in the flowcharts of FIG. 3-5 can be used separately, jointly, concurrently, or in other arrangements, depending on the particular embodiment of the present disclosure. For example, some embodiments of the present disclosure can only use the functionality depicted in FIG. 3, FIG. 4, or FIG. 5. However, other embodiments can make use of a combination or subcombination of the functionality depicted in FIG. 3, FIG. 4, and/or FIG. 5 in order to provide for an enhanced experience or increased security.

The client device 100 and/or other components described below can each include at least one processing circuit. Such a processing circuit can comprise one or more processors and one or more storage devices that are coupled to a local interface. The local interface can comprise a data bus with an accompanying address/control bus or any other suitable bus structure.

The one or more storage devices for a processing circuit can store data and/or components that are executable by the one or processors of the processing circuit. The management component 206 and/or other components can be stored in one or more storage devices and be executable by one or more processors. Also, a data store, such as the data store 213 can be stored in the one or more storage devices.

The management component 206, and other components described below can be embodied in the form of hardware, as software components that are executable by hardware, or as a combination of software and hardware. If embodied as hardware, the components described below can be implemented as a circuit or state machine that employs any suitable hardware technology. The hardware technology can include one or more microprocessors, discrete logic circuits having logic gates for implementing various logic functions upon an application of one or more data signals, application specific integrated circuits (ASICs) having appropriate logic gates, programmable logic devices (e.g., field-programmable gate array (FPGAs), and complex programmable logic devices (CPLDs)).

Also, one or more or more of the components described below that comprises software or program instructions can be embodied in any non-transitory computer-readable medium for use by or in connection with an instruction execution system such as a processor in a computer system or other system. Such a computer-readable medium can contain, store, and/or maintain the software or program instructions for use by or in connection with the instruction execution system.

The computer-readable medium can comprise physical media, such as, magnetic, optical, semiconductor, and/or other suitable media. Examples of a suitable computer-readable media include, but are not limited to, solid-state drives, magnetic drives, and flash memory. Further, any logic or component described below can be implemented and structured in a variety of ways. One or more components described can be implemented as modules or components of a single application. Further, one or more components described below can be executed in one computing device or by using multiple computing devices. Additionally, it is understood that terms such as “application,” “service,” “system,” “engine,” “module,” and so on, can be interchangeable and are not intended to be limiting unless indicated otherwise.

It is emphasized that the above-described embodiments of the present disclosure are merely examples of implementations to set forth for a clear understanding of the principles of the disclosure. Many variations and modifications can be made to the above-described embodiments without departing substantially from the spirit and principles of the disclosure. All such modifications and variations are intended to be included below within the scope of this disclosure.

1. A method, comprising:
identifying, by a client device, a request to render data through an output component of the client device;
determining, by the client device, that at least a portion of the data is protected data;
determining, by the client device, that a display of the client device is facing away from a user of the client device; and
reducing, by the client device, an intensity level associated with the output component of the client device, the intensity level associated with the output component of the client device being reduced to a level greater than zero.

2. The method of claim 1, wherein determining that the display of the client device is facing the user of the client device further comprises determining that the display is positioned at a predefined angle relative to a reference plane.

3. The method of claim 2, wherein the reference plane comprises the ground.

4. The method of claim 1, wherein determining that the display of the client device is facing away from the user of the client device is based at least in part on a result of a function provided by an application programming interface (API) of an operating system of the client device.

5. The method of claim 1, further comprising:
replacing, by the client device, the protected data with other data.

6. The method of claim 1, further comprising:
powering off, by the client device, the output component of the client device.

7. A non-transitory computer readable medium comprising a program, wherein the program is configured to cause a computing device to at least:
identify a request to render data through an output component of a client device;
determine that at least a portion of the data includes protected data;
identify a current angle of the client device relative to a reference plane;
determine whether a display of the client device is facing a user of the client device based at least in part on the current angle of the client device relative to a reference;
when it is determined that the display of the client device is not facing the user of the client device, cause an intensity level associated with the output component of the client device to be reduced, the intensity level associated with the output component of the client device being caused to be reduced to a level greater than zero; and,
when it is determined that the display of the client device is facing the user of the client device, cause the data including the protected data to be rendered through the output component of the client device.

8. The non-transitory computer readable medium of claim 7, wherein the current angle of the client device is determined by a sensor of the client device.

9. The non-transitory computer readable medium of claim 7, wherein the program is further configured to cause the computing device to at least:
when it is determined that the display of the client device is facing the user of the client device:
take a photograph of the user of the client device;
identify a face of the user of the client device in the photograph; and
determine whether the face of the user of the client device matches a face of an authorized user;
when the face of the user of the client device does not match the face of the authorized user, cause the client device to be in a locked state; and,
when the face of the user of the client device does match the face of the authorized user, cause the data including the protected data to be rendered through the output component of the client device.

10. The non-transitory computer readable medium of claim 7, wherein the data comprises a first data file, and wherein the program is further configured to cause the computing device to at least:
when it is determined that the display of the client device is not facing the user of the client device, cause a second data file to be rendered through the output component of the client device.

11. The non-transitory computer readable medium of claim 7, wherein the current angle comprises a first current angle, wherein the reference plane comprises a first reference plane, and wherein the program is further configured to at least:
identify a second current angle of the client device relative to a second reference plane;
determine whether the display of the client device is facing the user of the client device based at least in part on the second current angle relative to the second reference plane; and
when it is determined that the display of the client device is not facing the user of the client device, cause the client device to be in a locked state.

12. The non-transitory computer readable medium of claim 7, wherein the output component comprises the display of the client device, and wherein the intensity level associated with the output component comprises a brightness level associated with the display of the client device.

13. The non-transitory computer readable medium of claim 7, wherein the output component comprises a speaker of the client device, and wherein the intensity level associated with the output component comprises a volume level associated with the speaker of the client device.

14. A method, comprising:
determining, by a client device, a current orientation of the client device based at least in part on data provided by a sensor of the client device;
determining, by the client device, whether data currently rendered through an output component of the client device should be hidden based at least in part on the current orientation of the client device; and
when data currently rendered through the output component of the client device should be hidden based at least in part on the current orientation of the client device, reducing, by the client device, an intensity level associated with the output component of the client device to hide the data, the intensity level associated with the output component of the client device being reduced to a level greater than zero.

15. The method of claim 14, further comprising:
determining, by the client device, a subsequent orientation of the client device based at least in part on additional data provided by the sensor of the client device;
determining, by the client device, that the data should be rendered through the output component of the client device based at least in part on the subsequent orientation of the client device; and
authorizing, by the client device, the data to be rendered through the output component of the client device.

16. The method of claim 14, further comprising rendering, by the client device, other data through the output component of the client device.

17. The method of claim 14, further comprising:
photographing, by the client device, a face of a current user of the client device; and
determining, by the client device, whether data currently rendered through the output component of the client device should be hidden based at least in part on a comparison between the face of the current user of the client device and a face of an authorized user of the client device;
when data currently rendered through the output component of the client device should be hidden based at least in part on the comparison between the face of the current user of the client device and the face of the authorized user of the client device, reducing, by the client device, an intensity level associated with the output component of the client device to hide the data.

18. The method of claim 14, wherein the current orientation of the client device is relative to the ground.

19. The method of claim 14, wherein determining that the data currently rendered on the display of the client device should be hidden is further based at least in part on an attribute of the data.

20. The method of claim 14, wherein reducing, by the client device, the intensity level associated with the output component of the client device to hide the data occurs after a predefined period of time has elapsed.
